(19) United States
(12) Patent Application Publication
(10) Pub. No.: US 2005/0136169 A1
(43) Pub. Date: Jun. 23, 2005

(54) Stabilizing agent-free acid protein beverage composition and process for making same

(75) Inventors: Xiaolin Haung, (US); Joseph Lombardi, (US)

Correspondence Address: SOLAE, LLC, P. O. BOX 88940, ST. LOUIS, MO, 63188, US

(73) Assignee: SOLAE, LLC.

(21) Appl. No.: 10/741,502

(22) Filed: Dec. 19, 2003

(51) Int. Cl. C12C 1/00

(52) U.S. Cl. 426/590

(57) ABSTRACT

This invention is directed to a suspension stable protein containing acid beverage composition, comprising; (A) at least one protein material, (B) at least one flavoring material, (C) at least one sweetener, (D) at least one food grade acid, and (E) water; wherein the suspension stable protein containing acid beverage composition is free of a stabilizing agent, has a pH of from 3.0 to 3.7, and wherein for a 3 gram protein per 8 ounce composition has a viscosity at 25° C. of from 2 to 3 centipoise, less than 3% sediment and less than 1% serum, or wherein for a 6.5 gram protein per 8 ounce composition has a viscosity at 25° C. of from 3 to 5 centipoise, less than 5% sediment and less than 1% serum, or wherein for a 11 gram protein per 8 ounce composition has a viscosity at 25° C. of from 4 to 6 centipoise, less than 10% sediment and less than 1% serum.

### FIELD OF THE INVENTION

This invention relates to a suspension stable protein containing acid beverage compositions and particularly to acidic beverages that do not contain a stabilizing agent. Further, the invention relates to a process for producing such beverages.

### BACKGROUND OF THE INVENTION

Juices and other acidic juice-like beverages are popular commercial products. Consumer demand for nutritional healthy beverages has led to the development of nutritional juice or juice-like beverages containing protein. The protein provides nutrition in addition to the nutrients provided by the components of the beverage. Recently it has been discovered that certain proteins have specific health benefits beyond providing nutrition. For example, soy protein has been recognized by the United States Food and Drug Administration as being effective to lower blood cholesterol concentrations in conjunction with a healthy diet. In response, there has been a growing consumer demand for acidic juice-like beverages containing proteins that provide such specific health benefits.

A hurdle to adding protein to acidic beverages, however, is the relative insolubility of proteins in an aqueous acidic environment. Most commonly used proteins, such as soy proteins and casein, have an isoelectric point at an acidic pH. Thus, the proteins are least soluble in an aqueous liquid at or near the pH of acidic beverages. For example, soy protein has an isoelectric point at pH 4.5 and casein has an isoelectric point at a pH of 4.7, while most common juices have a pH in the range of 3.7 to 4.0. As a result, protein tends to settle out as a sediment in an acidic protein-containing beverage—an undesirable quality in a beverage.

Protein stabilizing agents that stabilize proteins as a suspension in an aqueous acidic environment are used to overcome the problems presented by protein insolubility. Pectin is a commonly used protein stabilizing agent. For example, Klavons et al. (U.S. Pat. No. 5,286,511) provide a beverage such as orange juice that is clouded by a suspension of soy protein particles, where the protein particles are prevented from aggregating to the point of settling out by pectin. Pectin inhibits the protein from settling by adsorbing to individual protein particles and imparting an overall negative charge to the protein particles, resulting in repulsion of the particles from one another, and thereby preventing the protein particles from aggregating and settling out of the suspension. Pectin also increases the viscosity of the beverage, which helps stabilize protein particles against gravitational forces.

Pectin, however, is an expensive food ingredient, and manufacturers of aqueous acidic beverages containing protein desire less expensive stabilizers, where the amount of required pectin is either reduced or removed in favor of less expensive stabilizing agents.

Acidic edible liquid compositions are well known. Such compositions include, for example, syrups, beverages, salad dressings, cordials, juices, certain jams and jellies, as well as fruit bakery filings. Traditional xanthan gum has often been used in such products to control the viscosity of the composition and modify its mouthfeel.

Beverages enjoy worldwide sales and the full mouthfeel of the beverage is very important in its customer acceptance. Beverages such as soft drinks may be stored in warehouses and are transported by ship, rail and truck. During such transportation and storage, as well as while on the store shelf, the stability of the beverage must be maintained. Low caloric beverages with juice have become very important to a more health and weight conscious society. It is important that such low caloric beverages continue to provide pleasant mouthfeel to customers.

Various compositions of acidic syrups and acidic beverages are known. Illustrative compositions include those disclosed in Flavor Technology, Soft Drinks and Beverages, Chapter 17, page 497, which notes that typical soft drinks, whether concentrated or not, contain ingredients such as fruit juices, natural essences, flavorings usually in the form of emulsions, colors, preservatives, heading and or clouding agents, acidulents, sugar and or high intensity sweetening agents and water. This publication is incorporated herein in its entirety by reference.

Mouthfeel modifiers like traditional xanthan gum can be added to acidic beverages, in particular carbonated soft drinks that are sweet and which contain one or more carbohydrate and/or high intensity sweeteners. While the use of traditional xanthan gum can modify the mouthfeel of a beverage, it has also been shown to suppress overall flavor and sweetness. And while traditional xanthan gum functions quite well initially in an acidic medium, over the typical shelf life of such an acidic product, the acidic product will lose viscosity. This is particularly true at elevated processing and storage temperatures, e.g., 21° C. to about 32° C. or more.

Thus there is a need for improved acidic edible liquid compositions, such as syrups and beverages, which are viscosity stable compositions in that they substantially maintain their viscosity or have a reduced viscosity loss over an extended time period compared to currently available products.

### SUMMARY OF THE INVENTION

This invention is directed to a suspension stable protein containing acid beverage composition, comprising;
(A) at least one protein material,
(B) at least one flavoring material,
(C) at least one sweetener,
(D) at least one food grade acid, and
(E) water;
wherein the suspension stable protein containing acid beverage composition is free of a stabilizing agent, has a pH of from 3.0 to 3.7, and
wherein for a 3 gram protein per 8 ounce composition has a viscosity at 25° C. of from 2 to 3 centipoise, less than 3% sediment and less than 1% serum, or
wherein for a 6.5 gram protein per 8 ounce composition has a viscosity at 25° C. of from 3 to 5 centipoise, less than 5% sediment and less than 1% serum, or
wherein for a 11 gram protein per 8 ounce composition has a viscosity at 25° C. of from 4 to 6 centipoise, less than 10% sediment and less than 1% serum.

Also disclosed is a process for preparing a suspension stable protein containing acid beverage composition, comprising the steps of, dispersing
(A) at least one protein material in water to obtain a dispersion, mixing and heating the protein in water dispersion, adding
(B) at least one flavoring material,
(C) at least one sweetener, and pasteurizing or sterilizing and homogenizing the composition wherein the suspension stable protein containing acid beverage composition is free of a stabilizing agent and has pH of from 3.0 to 3.7, and
wherein for a 3 gram protein per 8 ounce composition has a viscosity at 25° C. of from 2 to 3 centipoise, less than 3% sediment and less than 1% serum, or
wherein for a 6.5 gram protein per 8 ounce composition has a viscosity at 25° C. of from 3 to 5 centipoise, less than 5% sediment and less than 1% serum, or
wherein for a 11 gram protein per 8 ounce composition has a viscosity at 25° C. of from 4 to 6 centipoise, less than 10% sediment and less than 1% serum.

### DETAILED DESCRIPTION OF THE INVENTION

The Protein Material (A)

The protein material (A) of the composition and process of the present invention may be any vegetable or animal protein. Preferred protein materials useful in the composition of the present invention include soy protein materials, casein or caseinates, whey protein, corn protein materials—particularly zein, and wheat gluten.

Soybean protein materials which are useful with the present invention are soy flour, soy concentrate, and, most preferably, soy protein isolate. The soy flour, soy concentrate, and soy protein isolate are formed from a soybean starting material which may be soybeans or a soybean derivative. Preferably the soybean starting material is either soybean cake, soybean chips, soybean meal, soybean flakes, or a mixture of these materials. The soybean cake, chips, meal, or flakes may be formed from soybeans according to conventional procedures in the art, where soybean cake and soybean chips are formed by extraction of part of the oil in soybeans by pressure or solvents, soybean flakes are formed by cracking, heating, and flaking soybeans and reducing the oil content of the soybeans by solvent extraction, and soybean meal is formed by grinding soybean cake, chips, or flakes.

Soy flour, as that term is used herein, refers to a comminuted form of defatted soybean material, preferably containing less than 1% oil, formed of particles having a size such that the particles can pass through a No. 100 mesh (U.S. Standard) screen. The soy cake, chips, flakes, meal, or mixture of the materials are comminuted into a soy flour using conventional soy grinding processes. Soy flour has a soy protein content of about 40% to about 60%. Preferably the flour is very finely ground, most preferably so that less than about 1% of the flour is retained on a 300 mesh (U.S. Standard) screen.

Soy concentrate, as the term is used herein, refers to a soy protein material containing about 65% to about 90% of soy protein. Soy concentrate is preferably formed from a commercially available defatted soy flake material from which the oil has been removed by solvent extraction. The soy concentrate is produced by an acid leaching process or by an alcohol leaching process. In the acid leaching process, the soy flake material is washed with an aqueous solvent having a pH at about the isoelectric point of soy protein, preferably at a pH of about 4 to about 5, and most preferably at a pH of about 4.4 to about 4.6. The isoelectric wash removes a large amount of water soluble carbohydrates and other water soluble components from the flakes, but removes little of the protein, thereby forming a soy concentrate. The soy concentrate is dried after the isoelectric wash. In the alcohol leaching process, the soy flake material is washed with an aqueous ethyl alcohol solution wherein ethyl alcohol is present at about 60% by weight. The protein remains insoluble while the carbohydrate soy sugars such as sucrose, stachyose and raffinose are leached from the defatted flakes. The soy soluble sugars in the aqueous alcohol are separated from the insoluble protein and the insoluble protein is dried to form the soy concentrate.

Soy protein isolate, as the term is used herein, refers to a soy protein material containing about 90% or greater protein content, and preferably about 95% or greater protein content. Soy protein isolate is typically produced from a starting material, such as defatted soybean material, in which the oil is extracted to leave soybean meal or flakes. More specifically, the soybeans may be initially crushed or ground and then passed through a conventional oil expeller. It is preferable, however, to remove the oil contained in the soybeans by solvent extraction with aliphatic hydrocarbons, such as hexane or azeotropes thereof, and these represent conventional techniques employed for the removal of oil. The defatted, soy protein material or soybean flakes are then placed in an aqueous bath to provide a mixture having a pH of at least about 6.5 and preferably between about 7.0 and 10 in order to extract the protein. Typically, if it is desired to elevate the pH above 6.7 various alkaline reagents such as sodium hydroxide, potassium hydroxide and calcium hydroxide or other commonly accepted food grade alkaline reagents may be employed to elevate the pH. A pH of above about 7 is generally preferred, since an alkaline extraction facilitates solubilization of the protein. Typically, the pH of the aqueous extract of protein, will be at least about 6.5 and preferably about 7.0 to 10. The ratio by weight of the aqueous extractant to the soy protein material is usually between about 20 to 1 and preferably a ratio of about 10 to 1. In an alternative embodiment, the soy protein is extracted from the milled, defatted flakes with water, that is, without a pH adjustment.

It is also desirable in obtaining the soy protein isolate used in the present invention, that an elevated temperature be employed during the aqueous extraction step, either with or without a pH adjustment, to facilitate solubilization of the protein, although ambient temperatures are equally satisfactory if desired. The extraction temperatures which may be employed,, can range from ambient up to about 120° F. with a preferred temperature of 90° F. The period of extraction is further non-limiting and a period of time between about 5 to 120 minutes may be conveniently employed with a preferred time of about 30 minutes. Following extraction of the soy protein material, the aqueous extract of protein can be stored in a holding tank or suitable container while a second extraction is performed on the insoluble solids from the first aqueous extraction step. This improves the efficiency and yield of the extraction process by exhaustively extracting the protein from the residual solids from the first step.

The combined, aqueous protein extracts from both extraction steps, without the pH adjustment or having a pH of at least 6.5, or preferably about 7.0 to 10, are then precipitated by adjustment of the pH of the extracts to, at or near the isoelectric point of the protein to form an insoluble curd precipitate. The actual pH to which the protein extracts are adjusted will vary depending upon the soy protein material employed but insofar as soy protein, this typically is between about 4.0 and 5.0. The precipitation step may be conveniently carried out by the addition of a common food grade acidic reagent such as acetic acid, sulfuric acid, phosphoric acid, hydrochloric acid or with any other suitable acidic reagent. The soy protein precipitates from the acidified extract, and is then separated from the extract. The separated protein may be washed with water to remove residual soluble carbohydrates and ash from the protein material. The separated protein is then dried using conventional drying means such as spray drying or tunnel drying to form a soy protein isolate. Soy protein isolates are commercially available from Solae® LLC, for example, as SUPRO® PLUS 675, FXP 950, FXP HO120, SURPO® XT 40, SUPRO® 710, SUPRO® 720, ALPHA™ 5800, ALPHA™ 5812 and ALPHA™ 5811.

The protein material (A) may be denatured and hydrolyzed to lower the viscosity. Chemical denaturation and hydrolysis of protein materials is well known in the art and typically consists of treating a protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing the protein material are: a pH of up to about 10, preferably up to about 9.7; a temperature of about 50° C. to about 80° C. and a time period of about 15 minutes to about 3 hours, where the denaturation and hydrolysis of the protein material occurs more rapidly at higher pH and temperature conditions.

Hydrolysis of the protein material (A) may also be effected by treating the protein material with an enzyme capable of hydrolyzing the protein. Many enzymes are known in the art which hydrolyze protein materials, including, but not limited to, fungal proteases, pectinases, lactases, and chymotrypsin. Enzyme hydrolysis is effected by adding a sufficient amount of enzyme to an aqueous dispersion of the protein material, typically from about 0.1% to about 10% enzyme by weight of the protein material (A), and treating the enzyme and protein dispersion at a temperature, typically from about 5° C. to about 75° C., and a pH, typically from about 3 to about 9, at which the enzyme is active for a period of time sufficient to hydrolyze the protein material. After sufficient hydrolysis has occurred the enzyme is deactivated by heating, and the protein material (A) is precipitated from the solution by adjusting the pH of the solution to about the isoelectric point of the protein material (A).

One modified soy protein material is a soy protein isolate that has been enzymatically hydrolyzed and deamidated under conditions that expose the core of the proteins to enzymatic action as described in European Patent No. 0 480 104 B1, which is incorporated herein by reference. Briefly, the modified protein isolate material disclosed in European Patent No. 0 480 104 B1 is formed by: 1) forming an aqueous slurry of a soy protein isolate; 2) adjusting the pH of the slurry to a pH of from 9.0 to 11.0; 3) adding between 0.01 and 5% of a proteolytic enzyme to the slurry (by weight of the dry protein in the slurry); 4) treating the alkaline slurry at a temperature of 10° C. to 75° C. for a time period effective to produce a modified protein material having a molecular weight distribution (Mn) between 800 and 4000 and a deamidation level of between 5% to 48% (typically between 10 minutes to 4 hours); and deactivating the proteolytic enzyme by heating the slurry above 75° C. The modified protein material (A) disclosed in European Patent No. 0 480 104 B1 is commercially available from Solae LLC of St. Louis, Mo.

Casein protein materials useful in the composition and process of the present invention are prepared by coagulation of a curd from skim milk. The casein is coagulated by acid coagulation, natural souring, or rennet coagulation. To effect acid coagulation of casein, a suitable acid, preferably hydrochloric acid, is added to milk to lower the pH of the milk to around the isoelectric point of the casein, preferably to a pH of from 4.0 to 5.0, and most preferably to a pH of from 4.6 to 4.8. To effect coagulation by natural souring, milk is held in vats to ferment, causing lactic acid to form. The milk is fermented for a sufficient period of time to allow the formed lactic acid to coagulate a substantial portion of the casein in the milk. To effect coagulation of casein with rennet, sufficient rennet is added to the milk to precipitate a substantial portion of the casein in the milk. Acid coagulated, naturally soured, and rennet precipitated casein are all commercially available from numerous manufacturers or supply houses.

Whey protein isolates (WPI) can be obtained from commercial-scale fractionation of cheese whey by various processes, including ion-exchange processing using cationic and/or anionic resins selected for the intended functionality of the isolate. (Pearce, R. J., 1992, Whey protein recovery and whey protein fractionation, Whey and Lactose Processing, J G Zadow, Ed., Elsevier, London, 271-316).

Corn protein materials that are useful in the of the present invention include corn gluten meal, and most preferably, zein. Corn gluten meal is obtained from conventional corn refining processes, and is commercially available. Corn gluten meal contains about 50% to about 60% corn protein and about 40% to about 50% starch. Zein is a commercially available purified corn protein which is produced by extracting corn gluten meal with a dilute alcohol, preferably dilute isopropyl alcohol.

Wheat protein materials that are useful in the process of the present invention include wheat gluten. Wheat gluten is obtained from conventional wheat refining processes, and is commercially available.

Preferably the protein material (A) used in the present invention, is not modified by denaturation and hydrolysis.

The Flavoring Material (B)

A protein material by itself can have an undesired aftertaste or undesired flavors. The function of the flavoring material (B) is to mask any adverse flavors of the protein material (A) and to give a pleasant taste to the acid beverage composition. The flavoring material (B) comprises a fruit juice, a vegetable juice, vanilla flavor or almond flavor.

As a juice, the fruit and/or vegetable may be added in whole, as a liquid, a liquid concentrate, a puree or in another modified form. The liquid from the fruit and/or vegetable may be filtered prior to being used in the juice product. The fruit juice can include juice from tomatoes, berries, citrus fruit, melons and/or tropical fruits. A single fruit juice or fruit juice blends may be used. The vegetable juice can include a number of different vegetable juices. Examples of the few of the many specific juices which may be utilized in the present invention include juice from berries of all types, currants, apricots, peaches, nectarines, plums, cherries, apples, pears, oranges, grapefruits, lemons, limes, tangerines, mandarin, tangelo, bananas, pineapples, grapes, tomatoes, rhubarbs, prunes, figs, pomegranates, passion fruit, guava, kiwi, kumquat, mango, avocados, all types of melon, papaya, turnips, rutabagas, carrots, cabbage, cucumbers, squash, celery, radishes, bean sprouts, alfalfa sprouts, bamboo shoots, beans and/or seaweed. As can be appreciated, one or more fruits, one or more vegetables, and/or one or more fruits and vegetables, can be included in the acid beverage to obtain the desired flavor of the acid beverage.

Vanilla and almond flavors can also function as the flavoring material (B). Vanilla flavoring has been found to neutralize the aftertaste of protein materials. The vanilla flavoring may be a natural and/or artificial flavoring. As can be appreciated, the vanilla flavoring is best when used with other flavoring agents such as almond flavoring to mask and/or neutralize the undesired aftertaste and/or undesired flavors from the protein material. The flavoring agent content can be at least 1.5% of the acid beverage composition.

The Sweetener (C)

The acidic beverage composition will generally also contain at least one sweetener (C) in an amount effective to sweeten the composition with the balance of the composition typically being water. The purpose of the sweetener is to make the acid beverage more palatable. The sweeteners used in the compositions of this invention may be high intensity sweeteners or conventional caloric sweeteners. Such high intensity sweeteners may include, but are not limited to aspartame, acesulfame-K, sucralose, saccharin, alitame, cyclamates, stevia derivatives, thaumatin, or polyol sugar alcohols. Such caloric sweeteners may include but are not limited to sucrose (in liquid or granular form), high fructose corn syrup, invert sugar, dextrose, crystalline fructose, and high conversion corn syrup. Mixtures of sweeteners may also be employed as desired. The amount of sweetener or mixture of sweetener used in the compositions of this invention can be readily determined by one of ordinary skill in the art.

Food Grade Acid (D)

Food grade acids (D) comprising at least one of malic acid, citric acid, tartaric acid, phosphoric acid, folic acid, ascorbic acid, pantothenic acid or glucono delta lactone are added to the juice product to reduce the pH of the juice product.

The acidity of the acidic beverage composition is controlled by the addition of natural and/or organic acids. Preferably, citric acid is added to prepare the acidic beverage composition, however, other acids may be included in the acidic beverage composition. The acid is added in sufficient amounts to reduce the pH of the acidic beverage composition below 3.7. The acidity of the acidic beverage composition is selected to extend the shelf life, refrigerated or non-refrigerated, of the acidic beverage composition and/or to provide the desired degree of tartness of the acidic beverage composition. The pH of the acidic beverage composition is from 3.0 to 3.7, preferably from 3.1 to 3.6, and most preferably from 3.3 to 3.5.

Water (E)

Employed as water (E) is tap water, distilled water, deionized water, or carbonated water. The balance of the acid beverage composition is typically water.

In practicing this invention, water (E) at room temperature is added in sufficient quantity to form a dispersion in order to hydrate the protein material (A). It is critical to hydrate the protein material. The water and protein material are mixed with high shear mixing until the protein material is evenly dispersed. A suitable dispersion, once hydrated, contains from 0.5-10% by weight solids based on the weight of the dispersion. More preferably, the dispersion contains from 0.75-8% by weight solids. Most preferably the dispersion contains from 1-7% by weight solids. At this solids concentration which is indicated as most preferred for the dispersion, the most complete hydration is obtained of the protein. Thus, the water in the dispersion is used most efficiently at this concentration. The dispersion is heated to 170-175° F. and mixing is continued for about 10 minutes.

Following the preparation of the dispersion, the following are added in any order to the dispersion: the flavoring material (B), the sweetener (C) and the food grade acid (D). Additionally, coloring additives and vitamins may also be added. When vitamins are part of the formulation, the vitamins are added after the addition of the acid (D). This fully formulated acidic beverage composition is subjected to a pasteurization or sterilization step by heating the acidic beverage composition to a relatively high temperature for a short period of time. This pasteurization step kills microorganisms in the acidic beverage composition. For example, an effective treatment for killing microorganisms in the acidic beverage composition involves heating the acidic beverage composition to a temperature of about 180° F. for about 10 seconds, preferably to a temperature of at least 190° F. for at least 30 seconds and most preferably at a temperature of 195° F. for 60 seconds. While a temperature lower than 180° F. may work, a temperature of at least 180° F. provides a safety factor. Temperatures greater than 200° F. also have an effect on the killing of microorganisms. However, the cost associated with the higher temperature does not translate to a product that contains appreciably fewer harmful microorganisms. Further, pasteurizing at too high a temperature for too long a period of time may cause the protein to further denature, which generates more sediment due to the insolubility of the further denatured protein.

For sterilization, an effective temperature and time is 224° F. for at least 7 seconds.

Once the protein material (A) is pasteurized or sterilized, it then is homogenized. Homogenization serves to decrease the particle size of the protein in the protein dispersion (A). Preferably the dispersion is transferred to a Gaulin homogenizer (model 15MR) and is homogenized in two stages, a high pressure stage and a low pressure stage. The high pressure stage is from 1500-5000 pounds per square inch and preferably from 2000-3000 pounds per square inch. The low pressure stage is from 300-1000 pounds per square inch and preferably from 400-700 pounds per square inch.

After homogenization, the acidic beverage composition is then immediately bottled while hot, the bottles are laid on their sides for two minutes and then the bottles are cooled in an ice bath.

The present invention is directed to a suspension stable protein containing acid beverage composition. This composition is obtained without the use of a stabilizing agent. Known stabilizing agents are hydrocolloids comprising alginate, microcrystalline cellulose, jellan gum, tara gum, carrageenan, guar gum, locust bean gum, xanthan gum, cellulose gum and pectin. Of these, pectin is commonly used stabilizing agent. One problem associated with the use of stabilizing agents is the cost. The cost of the stabilizing agent is close to the cost of the protein material (A). Elimination of the stabilizing agent results in a lower cost product. Another problem associated with the use of stabilizing agents is the viscosity. By using stabilizing agents, a more viscous beverage is obtained than a beverage made without the use of a stabilizing agent. Within the present invention, the finished acidic beverage composition is free of a stabilizing agent, has a pH of from 3.0 to 3.7, and

wherein for a 3 gram protein per 8 ounce composition has a viscosity at 25° C. of from 2 to 3 centipoise, less than 3% sediment and less than 1% serum, or
wherein for a 6.5 gram protein per 8 ounce composition has a viscosity at 25° C. of from 3 to 5 centipoise, less than 5% sediment and less than 1% serum, or
wherein for a 11 gram protein per 8 ounce composition has a viscosity at 25° C. of from 4 to 6 centipoise, less than 10% sediment and less than 1% serum.

Example A is a baseline example for the preparation of an acidic beverage composition that utilizes a stabilizing agent. Stabilizing agents are not part of the present invention.

### EXAMPLE A

An 11.2 grams protein/8 ounces acid beverage composition is prepared by adding to a vessel 128 parts soy protein isolate identified as FXP H0220, available from Solae LLC St. Louis, Mo., 135 parts whey protein isolate available from New Zealand Milk Products, Santa Rose, Calif., 11.25 parts of YM100L, a high methoxyl pectin, 90.0 parts of Kelcoloid S propylene glycol alginate and 4339.5 parts deionized water. The contents are mixed under high shear until evenly dispersed. The dispersion is then heated to 170° F.±5F.° and mixed for an additional 10 minutes. Then added with mixing are 300 parts fructose, 25 parts fructooligosaccharide 18.5 parts anhydrous citric acid, 13.5 parts 85% phosphoric acid 11 parts mango flavor and 4 parts peach flavor. The pH is adjusted to 3.80 with 3 parts 85% phosphoric acid. The contents are homogenized at 2500 pounds per square inch in the first stage and at 500 pounds per square inch in the second stage followed by pasteurization at 95° C. for 60 seconds. Bottles are hot filled with the beverage and then placed in an ice bath to bring the temperature of the beverage to about room temperature. The bottles are stored for evaluation.

The invention having been generally described above, may be better understood by reference to the examples described below. The following Examples 1-5 represent specific but non-limiting embodiments of the present invention.

### EXAMPLE 1

Added to a vessel are a 130.0 parts soy protein isolate prepared in Memphis, Tenn., identified as FXP H0120, available from Solae LLC St. Louis, Mo. and 8539 parts deionized water. The contents are mixed under high shear until evenly dispersed. The dispersion is then heated to 170° F.±5F.° and mixed for an additional 10 minutes. Then added with mixing are 1180 parts high fructose corn syrup, 131 parts apple juice concentrate (68 Brix) and 20.0 parts anhydrous citric acid. The pH is adjusted to 3.8-4.0 with 85% citric acid. The contents are homogenized at 2500 pounds per square inch in the first stage and at 500 pounds per square inch in the second stage followed by pasteurization at 107° C. for 7 seconds. Bottles are hot filled with the beverage and then placed in an ice bath to bring the temperature of the beverage to about room temperature. The bottles are stored for evaluation.

### EXAMPLE 2

Added to a vessel are a 156.0 parts soy protein isolate prepared in Pryor, Okla., identified as FXP H0120, available from Solae LLC St. Louis, Mo. and 9605 parts deionized water. The contents are mixed under high shear until evenly dispersed. The dispersion is then heated to 160° F.±2F.° and mixed for an additional 10 minutes. Then added with mixing are 1416 parts high fructose corn syrup, 197 parts apple juice concentrate (68 Brix), 6.0 parts anhydrous citric acid, 9.0 parts phosphoric acid, and 1.0 parts calcium chloride. The contents are mixed for 3 minutes and the pH is adjusted to 3.55-3.6 with 85% citric acid. The contents are homogenized at 2500 pounds per square inch in the first stage and at 500 pounds per square inch in the second stage followed by pasteurization at 90-91° C. for 60 seconds. Bottles are hot filled with the beverage and then placed in an ice bath to bring the temperature of the beverage to about room temperature. The bottles are stored for evaluation.

### EXAMPLE 3

Added to a vessel are 41.7 parts soy protein isolate identified as FXP H0120, available from Solae LLC St. Louis, Mo. and 2583.8 parts deionized water. The contents are mixed under high shear until evenly dispersed. The dispersion is then heated to 170° F.±5F° and mixed for an additional 10 minutes. Then added with mixing are 300 parts sucrose, 63 parts white grape juice concentrate (68 Brix), 5.25 parts anhydrous citric acid, 2.1 parts sweetness enhancer and 4.1 parts natural orange pineapple flavor. The contents are homogenized at 2500 pounds per square inch in the first stage and at 500 pounds per square inch in the second stage followed by pasteurization at 91° C. for 30 seconds. Bottles are hot filled with the beverage, held for 2 minutes and then placed in an ice bath to bring the temperature of the beverage to about room temperature. The bottles are stored for evaluation.

### EXAMPLE 4

Added to a vessel are 90.3 parts soy protein isolate identified as FXP H0120, available from Solae LLC St. Louis, Mo. and 2530 parts deionized water. The contents are mixed under high shear until evenly dispersed. The dispersion is then heated to 170° F.±5F.° and mixed for an additional 10 minutes. Then added with mixing are 300 parts sucrose, 63 parts white grape juice concentrate (68 Brix), 10.5 parts anhydrous citric acid, 2.1 parts sweetness enhancer and 4.1 parts natural orange pineapple flavor. The contents are homogenized at 2500 pounds per square inch in the first stage and at 500 pounds per square inch in the second stage followed by pasteurization at 91° C. for 30 seconds. Bottles are hot filled with the beverage, held for 2 minutes and then placed in an ice bath to bring the temperature of the beverage to about room temperature. The bottles are stored for evaluation.

### EXAMPLE 5

An 11.2 grams protein/8 ounces acid beverage composition is prepared by adding to a vessel 128 parts soy protein isolate identified as FXP H0220, available from Solae LLC St. Louis, Mo., 135 parts whey protein isolate available from New Zealand Milk Products, Santa Rose, Calif. and 4339.5 parts deionized water. The contents are mixed under high shear until evenly dispersed. The dispersion is then heated to 170° F.±5F° and mixed for an additional 10 minutes. Then added with mixing are 300 parts fructose, 25 parts fructooligosaccharide 18.5 parts anhydrous citric acid, 13.5 parts 85% phosphoric acid 11 parts mango flavor and 4 parts peach flavor. The pH is adjusted to 3.51 with 13.5 parts 85% phosphoric acid. The contents are homogenized at 2500 pounds per square inch in the first stage and at 500 pounds per square inch in the second stage followed by pasteurization at 95° C. for 60 seconds. Bottles are hot filled with the beverage and then placed in an ice bath to bring the temperature of the beverage to about room temperature. The bottles are stored for evaluation.

The comparative acid beverage Example A is compared to the inventive acid beverage Example 6 in a side-by-side acid beverage test. The pH, viscosity, serum and sediment are determined at day 1 and day 56 of samples that have been refrigerated at 4° C. The side-by-side comparison is made by filling 250 milliliter narrow mouth square bottles (Nalge Nunc International) with each beverage. The percentage of sediment and percentage of serum of each sample is then measured to determine the effectiveness of stabilization in each beverage (Sediment=solid material that has fallen out of solution/suspension; Serum=clear layer of solution containing little or no suspended protein). The percentage of sediment is determined by measuring the height of the sediment layer in the sample and measuring the height of the entire sample, where Percent Sediment=(Ht. Sediment layer)/(Ht. Total Sample)×100. The percentage of serum is determined by measuring the height of the serum layer in the sample and measuring the height of the entire sample, where Percent Serum=(Ht. Serum Layer)/(Ht. Total Sample)×100. Visual observations are also made with respect to the homogenity, or lack thereof, of the samples. The results of the tests are shown in Table 1 below.

TABLE I
Acid Beverage Evaluations

| | Example A | | Example 5 | |
|---|---|---|---|---|
| | Day 1 | Day 56 | Day 1 | Day 56 |
| pH | 3.9 | 4.02 | 3.51 | 3.64 |
| Viscosity at 25° C.¹ | 83.6 Cps | 150.3 Cps | 5.0 Cps | 4.15 Cps |
| % Serum | slight | 22.1 | 0 | 0 |
| % Sediment | gel | gel | 0 | 9 |
| Observation | not stable | not stable | stable | stable |

¹Brookfield Model DV-II viscometer equipped with spindle S18.
Example A is run at 30 rpm and Example 5 is run at 60 rpm. The reported values are in centipoise (Cps).

For Example A, at day 1, there is a slight formation of serum, which is the top portion of the beverage. A slight thinning of color is noted here. At day 1, the sediment, which is the bottom portion of the beverage, is a gel. Gelation is not normally reversed with the passage of time. For Example A, at day 56 the serum value is 22%. At day 56, the sediment is still a gel. Based upon these observations, the acid beverage of Example A is not stable.

For Example 5, at both day 1 and at day 56, there is no formation of serum. At day 1, there is no sediment and at day 56 the sediment value is 9%. Further, the sediment can be redispersed by inverting the container several times. Based upon these observations, the acid beverage of Example 5 without a stabilizing agent, is more stable than the acid beverage of Example A that contains a stabilizing agent.

1. A suspension stable protein containing acid beverage composition, comprising;
(A) at least one protein material,
(B) at least one flavoring material,
(C) at least one sweetener,
(D) at least one food grade acid, and
(E) water;
wherein the suspension stable protein containing acid beverage composition is free of a stabilizing agent, has a pH of from 3.0 to 3.7, and
wherein for a 3 gram protein per 8 ounce composition has a viscosity at 25° C. of from 2 to 3 centipoise, less than 3% sediment and less than 1% serum, or
wherein for a 6.5 gram protein per 8 ounce composition has a viscosity at 25° C. of from 3 to 5 centipoise, less than 5% sediment and less than 1% serum, or
wherein for a 11 gram protein per 8 ounce composition has a viscosity at 25° C. of from 4 to 6 centipoise, less than 10% sediment and less than 1% serum.

2. The composition of claim 1 wherein the protein material (A) comprises a soybean protein material, casein, whey protein, wheat gluten or zein.

3. The composition of claim 2 wherein the soybean protein material comprises soy flour, soy concentrate or soy protein isolate.

4. The composition of claim 2 wherein the soybean protein material comprises soy protein isolate.

5. The composition of claim 1 wherein the protein material is not modified by denatuaration and hydrolysis.

6. The composition of claim 1 wherein the flavoring material (B) comprises a fruit juice or vegetable juice.

7. The composition of claim 1 wherein the sweetener (C) comprises sucrose, aspartame, acesulfame-K, sucralose, saccharin, alitame, cyclamates, stevia derivatives, thaumatin, polyol sugar alcohols, high fructose corn syrup, invert sugar, dextrose, crystalline fructose, or high conversion corn syrup.

8. The composition of claim 1 wherein the food grade acid (D) comprises malic acid, citric acid, tartaric acid, phosphoric acid, lactic acid, folic acid, ascorbic acid, pantothenic acid or glucono delta lactone.

9. The composition of claim 1 wherein the suspension stable protein containing acid beverage composition has a pH of from 3.1 to 3.6.

10. The composition of claim 1 wherein the suspension stable protein containing acid beverage composition has a pH of from 3.3 to 3.5.

11. A process for preparing a suspension stable protein containing acid beverage composition, comprising the steps of; dispersing
(A) at least one protein material in water to obtain a dispersion, mixing and heating the protein in water dispersion, adding
(B) at least one flavoring material,
(C) at least one sweetener, and
(D) at least one food grade acid, and pasteurizing or sterilizing and homogenizing the composition wherein the suspension stable protein containing acid beverage composition is free of a stabilizing agent and has pH of from 3.0 to 3.7, and
wherein for a 3 gram protein per 8 ounce composition has a viscosity at 25° C. of from 2 to 3 centipoise, less than 3% sediment and less than 1% serum, or
wherein for a 6.5 gram protein per 8 ounce composition has a viscosity at 25° C. of from 3 to 5 centipoise, less than 5% sediment and less than 1% serum, or
wherein for a 11 gram protein per 8 ounce composition has a viscosity at 25° C. of from 4 to 6 centipoise, less than 10% sediment and less than 1% serum.

12. The process of claim 1 lwherein the protein material (A) comprises a soybean protein material, casein, whey protein, wheat gluten or zein.

13. The process of claim 11 wherein the soybean protein material comprises soy flour, soy concentrate or soy protein isolate.

14. The process of claim 11 wherein the soybean protein material comprises soy protein isolate.

15. The composition of claim 11 wherein the protein material is not modified by denatuaration and hydrolysis.

16. The process of claim 11 wherein the flavoring material (B) comprises a fruit juice or a vegetable juice.

17. The process of claim 11 wherein the sweetener (C) comprises sucrose, aspartame, acesulfame-K, sucralose, saccharin, alitame, cyclamates, stevia derivatives, thaumatin, polyol sugar alcohols, high fructose corn syrup, invert sugar, dextrose, crystalline fructose, or high conversion corn syrup.

18. The process of claim 11 wherein the food grade acid (D) comprises malic acid, citric acid, tartaric acid, phosphoric acid, lactic acid, folic acid, ascorbic acid, pantothenic acid or glucono delta lactone.

19. The process of claim 11 wherein the suspension stable protein containing acid beverage composition has a pH of from 3.1 to 3.6.

20. The process of claim 11 wherein the suspension stable protein containing acid beverage composition has a pH of from 3.3 to 3.5.

21. The process of claim 11 wherein pasteurization is carried out at a temperature of at least 180° F. for at least 10 seconds.

22. The process of claim 11 wherein pasteurization is carried out at a temperature of at least 190° F. for at least 30 seconds.

23. The process of claim 11 wherein pasteurization is carried out at a temperature of at least 195° F. for at least 60 seconds.

24. The process of claim 11 wherein sterilization is carried out at a temperature of at least 224° F. for at least 7 seconds.

25. The process of claim 11 wherein the homogenization of (A) and the homogenization of the blend is carried out in two stages.

26. The process of claim 25 wherein the two stages are a high pressure stage and a low pressure stage.

27. The process of claim 26 wherein the high pressure stage is from 1500-5000 pounds per square inch.

28. The process of claim 26 wherein the high pressure stage is from 2000-3000 pounds per square inch.

29. The process of claim 26 wherein the low pressure stage is from 300-1000 pounds per square inch.

30. The process of claim 26 wherein the low pressure stage is from 400-700 pounds per square inch.
